(19) United States
(12) Patent Application Publication
(10) Pub. No.: US 2014/0164649 A1
(43) Pub. Date: Jun. 12, 2014

(54) ELECTRONIC EQUIPMENT, CONTROL METHOD OF ELECTRONIC EQUIPMENT, AND CONTROL PROGRAM OF ELECTRONIC EQUIPMENT

(71) Applicant: Kabushiki Kaisha Toshiba, Tokyo (JP)

(72) Inventor: Akiyoshi SOUGEN, Ome-shi (JP)

(73) Assignee: Kabushiki Kaisha Toshiba, Tokyo (JP)

(21) Appl. No.: 13/966,990

(22) Filed: Aug. 14, 2013

(30) Foreign Application Priority Data
Dec. 7, 2012 (JP) 2012-268828

(51) Int. Cl. G06F 9/44

(52) U.S. Cl. CPC G06F 9/4413
USPC 710/13

(57) ABSTRACT

According to one embodiment, an electronic equipment, includes: a connection detecting module, a referring module, and an output module. The connection detecting module configured to detect connection of an external storage device. The referring module configured to refer to a predetermined type of media file from the external storage device when the connection is detected. The output module configured to output the predetermined type of media file preferentially to other types based on the reference. The electronic equipment can improve a convenience of a user by reducing the complexity when the user looks for a desired data (media file, application software) when the external storage device (USB memory) is connected to the electronic equipment.

### CROSS REFERENCE TO RELATED APPLICATION(S)

The application is based upon and claims the benefit of priority from Japanese Patent Application No. 2012-268828 filed on Dec. 7, 2012; the entire contents of which are incorporated herein by reference.

### FIELD

Embodiments described herein relate to an electronic equipment, a control method of the electronic equipment, and a control program of the electronic equipment.

### BACKGROUND

Recently, an external storage device is widely used, which copes with “mounting/demounting while turning ON” of an electronic equipment such as a computer.

The “mounting/demounting while turning ON” indicates, for example, that a component or a cable is exchanged while turning ON a computer (electronic equipment).

Further, a case where a component is mounted in a computer (electronic equipment) while the computer (electronic equipment) is electrically conducted is referred to as “hot plug”. In some cases, “hot swapping” and “hot plug” are used to have the same meanings.

Further, in a large scale computer which is strictly required to be continuously operated, the equipment such as a hard disk copes with “hot swapping” and then is multiplexed. When failure occurs, a device may be exchanged without stopping the system in many cases.

The “hot swapping” also indicates that a component or a cable is exchanged while turning ON a computer.

In the electronic equipment such as a personal computer (PC), for example, a PC card, or an input/output standard such as a universal serial bus (USB) and IEEE 1394 copes with the “hot swapping”.

Further, as an example of an external storage device which copes with “mounting/demounting while turning ON” of the electronic equipment, there is, for example, a USB memory.

The USB memory operates as a single body using a semiconductor memory as a recording medium, among auxiliary storage devices which are connected to a computer using a universal serial bus (USB) to read and write data.

In recent years, a storage capacity of an external storage device (for example, a USB memory) is increased so that it is possible to store a large number of media files.

However, when the external storage device (USB memory) in which a large number of media files are stored is connected to the electronic equipment, if too much data (for example, the number of stored media files is too much) is stored, an operation to find a desired data (media file) may be complex.

Therefore, an object is to improve a convenience of a user by reducing the complexity when the user looks for a desired data (media file) when an external storage device (USB memory) is connected to an electronic equipment.

It is desired to improve a convenience of a user by reducing the complexity when the user looks for a desired data (media file, application software) when the external storage device (USB memory) is connected to the electronic equipment.

### BRIEF DESCRIPTION OF THE DRAWINGS

Exemplary embodiments of the present invention will be described in detail based on the following figures, wherein:

FIG. 1 is a view illustrating an appearance of an electronic equipment according to an embodiment;

FIG. 2 is a block diagram illustrating an example of a configuration of the electronic equipment (tablet) according to the embodiment;

FIG. 3 is a view illustrating a priority media designating module to designate a priority media that is output from the electronic equipment according to the embodiment; and

FIG. 4 is a flow chart illustrating operations of the electronic equipment according to the embodiment.

### DETAILED DESCRIPTION OF THE EXEMPLARY EMBODIMENTS

An object of the embodiments is to provide an electronic equipment includes a connection detecting module that detects the connection of an external storage device. The electronic equipment further includes a referring module that, when the connection is detected, refers to a predetermined type of media file (application software) from the external storage device. The electronic equipment further includes an output module that preferentially outputs the predetermined type of media file (application software) to other types of media files based on the above reference.

Hereinafter, one embodiment will be described with reference to the drawings.

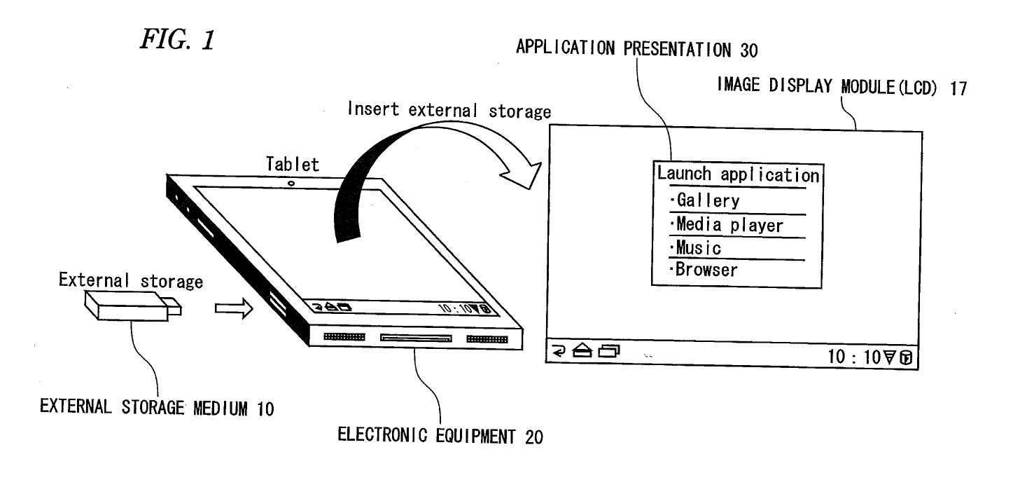

FIG. 1 is a view illustrating an appearance of an electronic equipment according to an embodiment.

In this embodiment, an external storage device 10 copes with “mounting/demounting while turning ON” of an electronic equipment (tablet) 20.

As illustrated in FIG. 1, in the electronic equipment (tablet) 20 of the embodiment, when the external storage device 10 such as a USB memory is connected to the electronic equipment (tablet) 20, the electronic equipment (tablet) 20 detects the connection of the external storage device 10 (connection detecting module).

When the connection is detected, as described below, a predetermined type of media file (application software) is referred from the external storage device 10 (referring module).

The predetermined type of media file (application software) is preferentially output to other types of media files (application software) based on the above reference (output module), for example, as illustrated in an application presentation 30 displayed on an image display module 17 of FIG. 1.

Here, for example, the type of media file includes extension information.

Here, a predetermined type of media file (application software) is presented in the application presentation 30.

In the application presentation 30, for example, “Launch Application” is displayed and predetermined types of media files (application software) such as “Gallery”, “Media Player”, “Music”, and “Browser” are presented.

Further, even though the tablet is described as an example of the electronic equipment 20, the embodiment is not limited thereto, but is also applicable to an electronic equipment such as, for example, a smart phone, a personal computer (PC), or a television.

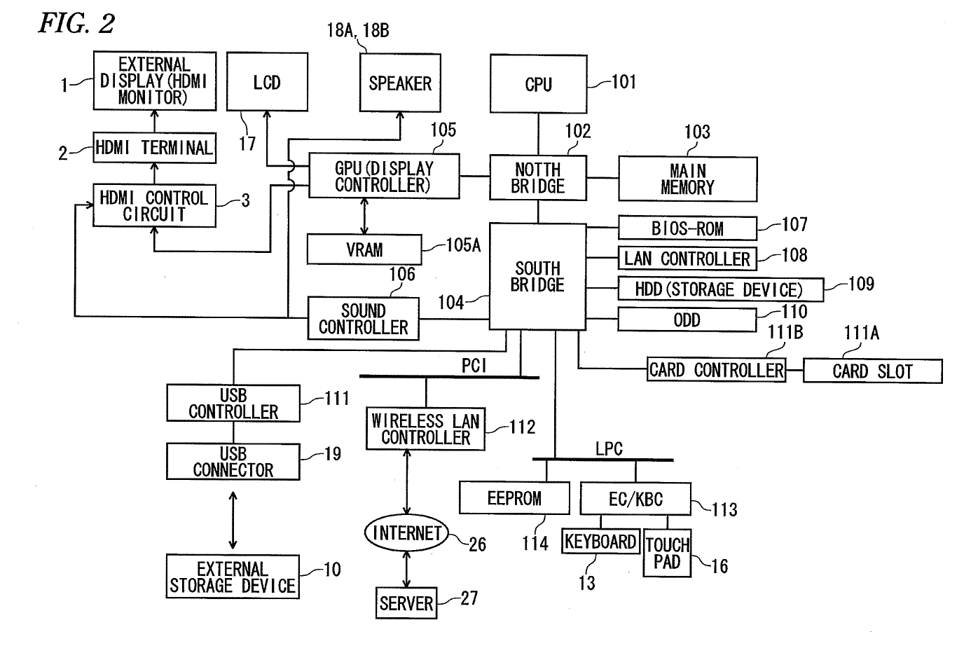

FIG. 2 is a block diagram illustrating an example of a configuration of the electronic equipment (tablet) according to the embodiment.

The electronic equipment (tablet) 20, for example, includes a central processing unit (CPU) 101, a north bridge 102, a main memory 103, a south bridge 104, a graphics processing unit (GPU) 105, a video RAM (VRAM: video random access memory) 105A, a sound controller 106, a basic input/output system-read only memory (BIOS-ROM) 107, a local area network (LAN) controller 108, a hard disk drive (HDD; storage device) 109, an optical disk drive (ODD) 110, a USB controller 111, a card controller 111B, a wireless LAN controller 112, an embedded controller/keyboard controller (EC/KBC) 113, and an electrically erasable programmable ROM (EEPROM) 114.

Here, the CPU 101 is a processor that controls operations of individual parts in the electronic equipment (tablet) 20.

Further, the CPU 101 executes a BIOS stored in the BIOS-ROM 107. The BIOS is a program that controls the hardware.

The north bridge 102 is a bridge device that connects between a local bus of the CPU 101 and the south bridge 104. The north bridge 102 includes a memory controller built therein that accesses the main memory 103 to control the main memory 103. Further, the north bridge 102 also has a function that performs communication with the GPU 105 through, for example, a PCI EXPRESS standard serial bus.

The GPU 105 is a display controller that controls the image display module (LCD) 17 which is used as a display monitor of the electronic equipment (tablet) 20.

A display signal which is generated by the GPU 105 is sent to the image display module (LCD) 17. Further, the GPU 105 may transmit a digital image signal to an external display 1 through an HDMI control circuit 3 and an HDMI terminal 2.

The HDMI terminal 2 is a connection terminal for the external display 1 as described above. The HDMI terminal 2 may transmit a digital image signal and a digital audio signal, which are not compressed, to the external display 1 such as a television through a single line of cable. The HDMI control circuit 3 is an interface that transmits the digital image signal to the external display 1, which is called as an HDMI monitor, through the HDMI terminal 2.

The south bridge 104 controls each device on a peripheral component interconnect (PCI) bus, and each device on a low pin count (LPC) bus. Further, the south bridge 104 includes an integrated drive electronics (IDE) controller built therein that controls the HDD 109 and the ODD 110.

The sound bridge 104 also has a function that performs communication with the sound controller 106.

The sound controller 106 is a sound source device and outputs audio data to be reproduced to speakers 18A and 18B or the HDMI control circuit 3. The LAN controller 108 is, for example, a wired communication device that performs wired communication in accordance with IEEE 802.3 standard. Further, the wireless LAN controller 112 is, for example, a wireless communication device that performs wireless communication in accordance with IEEE 802.11 g standard. The USB controller 111 performs communication with an external equipment (which is connected through the USB connector 19) in accordance with, for example, USB 2.0 standard.

For example, the USB controller 111 is used to receive an image data file which is stored in, for example, a digital camera. The card controller 111B writes and reads data in and from a memory card such as an SD card which is inserted in a card slot 111A provided in a main body of a computer (notebook PC).

The EC/KBC 113 is a single chip microcomputer in which an embedded controller that manages power and a keyboard controller which controls the keyboard 13 and a touch pad 16 are integrated. The EC/KBC 113 has a function that turns ON/OFF power of the electronic equipment (tablet) 20 in accordance with the manipulation of a power button by a user.

The display control in the embodiment is performed, for example, by causing the CPU 101 to execute a program recorded in, for example, the main memory 103 or the HDD 109.

In the meantime, the above description is for illustration purpose only and the electronic equipment according to the embodiment may be configured by hardware which is different from the above configuration.

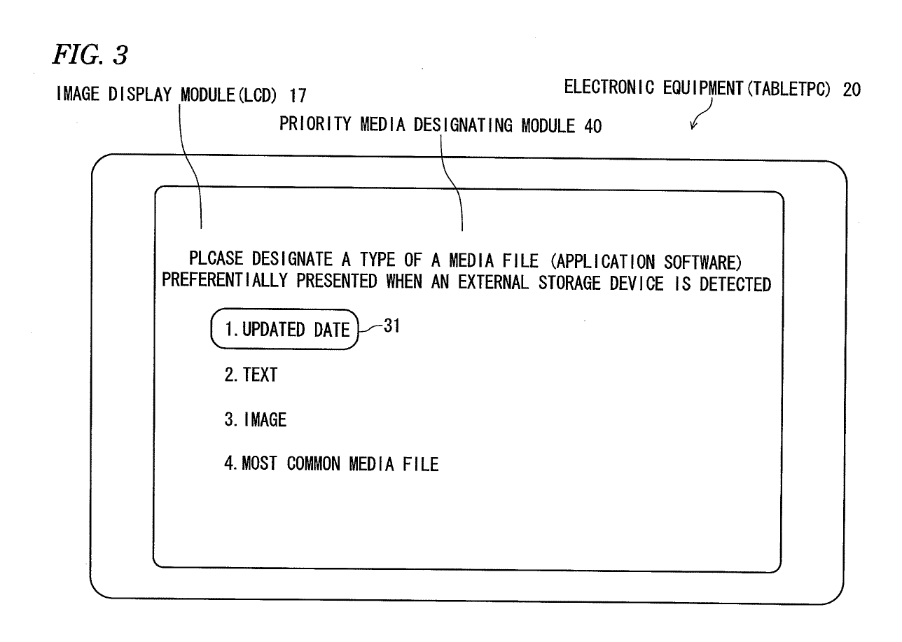

FIG. 3 is a view illustrating a priority media designating module that designates a priority media which is output from the electronic equipment according to the embodiment.

As illustrated in FIG. 3, a priority media designating module 40 is displayed on the image display module 17 of the electronic equipment 20.

In the priority media designating module 40, “Please designate a type of a media file (application software) preferentially presented when an external storage device is detected” is displayed. Therefore, a user may designate a type of media file (application software) which is preferentially output to other types of media files (application software) among media files (application software) stored in the external storage device 10.

For example, when it is detected that the external storage device 10, which copes with “mounting/demounting while turning ON”, is connected to the electronic equipment (tablet) 20, the predetermined type of media file (application software) is preferentially output to other types with reference to the predetermined type of media file (application software) by the user from the external storage device 10 (see, for example, FIG. 1, “application presentation 30”).

In the meantime, the type of media file (application software) may be set as a default.

Here, for example, an “updated date” 31 is designated by the user.

In this case, a predetermined type of media file (that is, the updated date is new) is preferentially output to other types of media files (the updated date is not new) from the external storage device 10 with reference to the predetermined type of media file (“updated date” 31, here, the updated date is new).

Further, in the embodiment, as a type of media file (application software) which is preferentially output to other types of media files (application software) among the media files (application software) stored in the external storage device 10, as illustrated in FIG. 3, for example, “Text”, “Image”, or “Most common media files (application software)” may be designated.

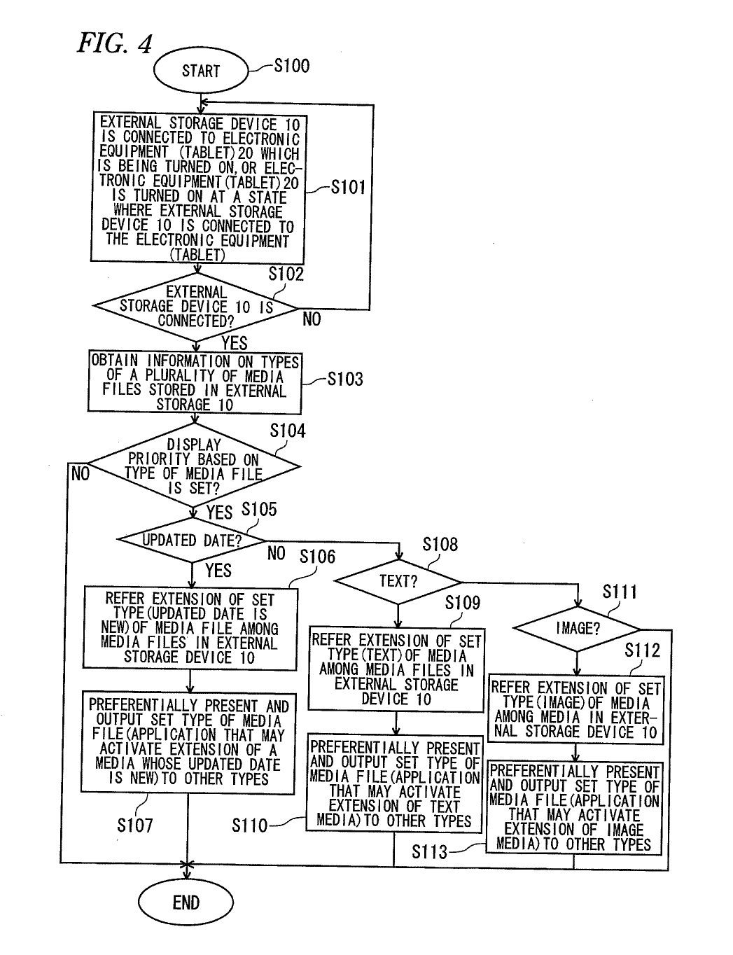

FIG. 4 is a flow chart illustrating operations of the electronic equipment according to the embodiment.

Step S100 is a start step. Next, a sequence proceeds to step S101.

At step S101, the external storage device 10 copes with “mounting/demounting while turning ON” of the electronic equipment 20. The external storage device 10 is connected to the electronic equipment (tablet) 20 which is being turned ON or the electronic equipment (tablet) 20 is turned ON at a state where the external storage device 10 is connected to the electronic equipment (tablet) 20. Continuously, the sequence proceeds to step S102.

At step S102, it is detected whether the external storage device 10 is connected to the electronic equipment 20. When it is detected that the external storage device 10 is connected to the electronic equipment 20, the sequence proceeds to step S103 (“Yes”). When it is not detected that the external storage device 10 is connected to the electronic equipment 20, the sequence proceeds to step S101 to repeat the above processes (“No”).

At step S103, for example, information on types of a plurality of media files (application software) which are stored in the external storage device 10 is obtained. Next, the sequence proceeds to step S104.

At step S104, it is detected that a display priority is set based on the type of media file (application). When the display priority is set based on the type of media file (application), the sequence proceeds to step S105 (“Yes”). When the display priority is not set based on the type of media file (application), the sequence proceeds to step S114 (“No”).

At step S105, it is detected whether the set type of media file (application) is an “updated date”. When it is detected that the set type of media file (application) is the “updated date”, the sequence proceeds to step S106 (“Yes”). When it is detected that the set type of media file (application) is not the “updated date”, the sequence proceeds to step S108 (“No”).

At step S106, an extension of the set type (the updated date is new) of media file (application software) is referred among the media files (application software) in the external storage device 10. Next, the sequence proceeds to step S107.

At step S107, the set type of media file (an application that may activate an extension of a media whose updated date is new) is preferentially presented and output to other types. Next, the sequence proceeds to step S114.

At step S108, it is detected whether the set type of media file (application) is a “text”. When it is detected that the set type of media file (application) is the “text”, the sequence proceeds to step S109 (“Yes”). When it is detected that the set type of media file (application) is not the “text”, the sequence proceeds to step S111 (“No”).

At step S109, an extension of the set type (text) of media is referred among the media files (application software) in the external storage device 10. Next, the sequence proceeds to step S110.

At step S110, the set type of media file (an application that may activate an extension of a text media) is preferentially presented and output to other types. Next, the sequence proceeds to step S114.

At step S111, it is detected whether the set type of media file (application) is an “image”. When it is detected that the set type of media file (application) is the “image”, the sequence proceeds to step S112 (“Yes”). When it is detected that the set type of media file (application) is not the “image”, the sequence proceeds to step S114 (“No”).

At step S112, the extension of the set type (image) of media is referred among the media in the external storage device 10. Next, the sequence proceeds to step S113.

At step S113, the set type of media file (an application that may activate an extension of an image media) is preferentially presented and output. Next, the sequence proceeds to step S114.

In the meantime, the above-described operations may also be performed on the “most common media file (application software)”.

Step S114 is an end step and the process is completed at step S114.

In other words, in the embodiment, the electronic equipment 20 includes the connection detecting module (not illustrated) which detects the connection of the external storage device.

Further, the electronic equipment 20 includes the referring module (not illustrated) that refers to a predetermined type of media file (application software) from the external storage device when the connection is detected.

Furthermore, the electronic equipment includes the output module that preferentially outputs the predetermined type of media file (application software) to other types of media files based on the above reference (see FIG. 1, “application presentation 30”).

Further, in the embodiment, when the connection is detected, the electronic equipment 20 acquires information on the types of plurality of media files (application software) stored in the external storage device 10.

Further, the electronic equipment 20 detects the connection of the external storage device 10 in a state where the power is ON or a state where the power is ON while the external storage device is connected to the electronic equipment.

Further, in the electronic equipment 20, the predetermined type includes any one of the updated date, the text, and the image of the plurality of media files (application software).

The electronic equipment 20 includes the designating module (see FIG. 3) that may designate a type of media file (application software) which is preferentially output.

The external storage device 10 includes a storage medium such as a semiconductor memory.

The external storage device 10 includes a USB memory.

The embodiment may also be applied to, for example, a PC card or an external storage device which copes with input/output standard such as IEEE 1394 which cope with the “hot swapping”, as the external storage device which copes with the “mounting/demounting while turning ON” of the electronic equipment.

In other words, the embodiment suggests a media file (application software) which activates based on the state of the media in the external storage device when it is detected that the external storage device which copes with the “mounting/demounting while turning ON” or equipment including the external storage device mounted therein are inserted into the electronic equipment.

Further, when a plurality of types of media files (application software) are present in an external storage device, a priority is applied to the display order of the presented application so that the user may easily select a more preferable application.

Further, the user may set a method that applies a priority to present an activating media file (application software) in the electronic equipment.

Further as a method that selects the activating media file (application software), when it is selected to refer to the latest media file (application software), it is possible to preferentially present a media file (application software) which may activate a file having an extension by referring to the extension of a media file (application software) whose updated date is newest among the media in the external storage device.

As one of selecting methods of activating media files (application software), when it is selected to refer to a type of most common media files, it is possible to preferentially present an application that may activate a file having an extension by referring to the type of the most common media file among the media files (application software) present in the external storage device.

Accordingly, as compared with a process that depends on an external device that activates a predetermined application, for example, when an install state of a predetermined external device is detected, the embodiment may present an activating application so as to apply a priority to the application based on the type of media file (application software) in the external storage device without depending on a specific external device.

By doing this, a user may easily select a desired application.

With this configuration, in the embodiment, when an external storage device is connected to an electronic equipment, it is possible to improve convenience for a user while reducing complexity when looking for a desired data (media file, application software).

In the meantime, all sequences of a control process of the above embodiment may be executed by software. Therefore, the same effect as the above embodiment may be easily achieved only by installing and executing a program in a general computer through a computer readable storage medium in which the program executing the sequence of the control process is stored.

Meanwhile, the embodiment is not limited to the technology as it is but the components may be modified and specified in various manners without departing from the gist of the invention in a practical phase.

Further, a plurality of components disclosed in the above embodiment may be appropriately combined to form various inventions.

For example, several components may be omitted from the entire components disclosed in the embodiment. Further, components over different embodiments may be appropriately combined.

What is claimed is:

1. An electronic equipment, comprising:
a connection detecting module configured to detect connection of an external storage device;
a referring module configured to refer to a predetermined type of media file from the external storage device when the connection is detected; and
an output module configured to output the predetermined type of media file preferentially to other types based on the reference.

2. The electronic equipment of claim 1, wherein information on types of a plurality of media files stored in the external storage device is obtained when the connection is detected.

3. The electronic equipment of claim 1, wherein the type of media file includes extension information.

4. The electronic equipment of claim 1, wherein the connection of the external storage device is detected in a state when power is ON or a state where power is turned ON while the external storage device is connected to the electronic equipment.

5. The electronic equipment of claim 1, wherein the predetermined type includes any one of an updated date, a text and an image of the plurality of media files.

6. The electronic equipment of claim 1, further comprising:
a designating module configured to designate a type of media file which is preferentially output.

7. The electronic equipment of claim 1, wherein the external storage device includes a storage medium.

8. The electronic equipment of claim 1, wherein the external storage device includes a USB memory.

9. A control method of an electronic equipment, comprising:
detecting a connection of an external storage device;
when the connection is detected, referring to a predetermined type of media file from the external storage device; and
outputting the predetermined type of media file preferentially to other types based on the reference.

10. A non-transitory computer-readable medium storing a program that causes an electronic equipment to execute image processing, the image processing comprising:
detecting a connection of an external storage device;
when the connection is detected, referring to a predetermined type of media file from the external storage device; and
outputting the predetermined type of media file preferentially to other types based on the reference.
